(19) United States
(12) Patent Application Publication
(10) Pub. No.: US 2005/0235619 A1
(43) Pub. Date: Oct. 27, 2005

(54) Filter medium

(76) Inventors: Beate Heinz, Schwerte (DE); Immo Schnieders, Hatzfeld (DE)

Correspondence Address: CLARK & BRODY, 1090 VERMONT AVENUE, NW, SUITE 250, WASHINGTON, DC, 20005, US

(21) Appl. No.: 10/515,423

(22) PCT Filed: May 28, 2003
(86) PCT No.: PCT/EP03/05626

§ 371 Date: Jun. 24, 2005

(30) Foreign Application Priority Data
May 28, 2002 (EP) 02011827.9

(51) Int. Cl. B01D 46/00

(52) U.S. Cl. 55/486; 55/528

(57) ABSTRACT

A filter medium (10) is fashioned in a way, to effectively catch not only microparticles but also particles having nanometer dimensions. According to the invention, it comprises at least one supporting layer (20) and at least one fine fiber layer (30), the former preferably being composed of crosslinked cellulose fibers and microglass fibers, or alternatively of polymeric fibers. The diameters of the fibers in the supporting layer (20) are in the micron range and the pores of this layer mostly have cross-sections in the square micron range. The very light fine fiber layer (30) having a weight per unit area of less than 1 g/m² possesses pores ranging down to nanometer dimensions and is thermally stable at temperatures above 180° C. It comprises fibers (40) obtained from polymers by electrostatic spinning and having diameters in the nanometer range. In order to crosslink individual fibers (40) with each other or with the supporting layer (20) and thus to render them insoluble in water and chemically and thermally stable, various resins, for example, melamine resins are used. For protection and stability purposes, the filter medium (10) can be supplemented with backing or cover layers.

The invention relates to a filter medium for use in thru-flow contrivances as defined in the generich term of claim 1, and to a process for the production of such a filter medium as defined in the generic term of claim 20.

Filter media have diverse uses when required to separate particles from a stream of air or gas or to separate solid material from a solid-liquid phase or to maintain a specific concentration thereof. They are used, for example, in the form of pleated filters of cellulose in the laboratory, or equally well as flat filters in ventilation systems, such as are present in, say, automobiles.

Filtering performance requirements are always on the increase. In particular, increasingly smaller particles and increasingly wider particle-size distributions must be effectively filtered whilst at the same time the dust-holding capacity must be raised. These performance demands cannot be satisfied by a single thin non-woven layer of, say, cellulose fibers. A thicker form of such a filter would be cost-intensive. Besides, the operating costs of the filter would increase, since a similar rate of flow through a thicker filter medium can only be achieved using a higher pressure.

Donaldson has approached this problem with the introduction of a filter medium consisting of several layers (data sheet 08.04.1998). To a polyester nonwoven there is applied a 1 μm to 20 μm thick efficiency layer of organic polymer fibers having fiber diameters between 150 nm and 200 nm, the fibrous material being preferably polyacrylonitrile, polyvinylidene chloride or polycarbonate. Such a filter medium is attributed to successfully hold back particles having a size of half a micron or larger particles to an extent of more than 90%, but no statements are made on how quickly such a filter medium chokes up. DE-U. 1-299 07 699 describes filter media having similar properties.

In order to impart adequate stability and, if required, a resistance to chemicals and a robust character to these filter types and to those using, as substrate layers, almost exclusively cellulose fibers, their fibers would have to be impregnated with reactive resins or resin formulations, for example, phenolic resins, and the filter then thermocured at temperatures above 150° C. However, the said filter media could not stand such heat treatment because the efficiency layer is almost completely destroyed at higher temperatures for instance above 150° C. Particles having diameters below one micrometer can consequently no longer be retained, and the desired filtering action is lost. The same problems are met when the known filter media are used under extreme environmental conditions, particularly at high temperatures and in aggressive atmospheres or solutions.

It is an object of the invention to overcome these and other drawbacks of the prior art using simple means and to provide an improved filter medium which can be used under extreme environmental or operational conditions and exhibits a constantly high filtering performance. It should be capable of being produced cheaply in large numbers in a manner which is environmentally acceptable. Also desirable is a high dust-catching capacity, and the filter medium should exhibit adequate stability at relatively small overall thicknesses.

The main features of the invention are described in the characterizing part of claims 1 and 20. Embodiments are the subject matter of claims 2 to 19 and 21 to 23.

In a filter medium for use in thru-flow contrivances, containing at least one supporting layer and at least one fine fiber layer permanently adhering to said supporting layer, said fine fiber layer comprising electrostatically spun polymer fibers having an average fiber diameter of less than and/or equal to 1 μm, the invention provides that due to the action of a catalyst, the polymer fibers are crosslinked with each other directly or indirectly via a crosslinking agent (crosslinker), which crosslinker and/or the crosslinked polymer fibers are resistant to temperatures of up to 200° C.

Experiments have shown that a filter structure of this kind achieves excellent filtering of a large cross-section of particle sizes. The ability to filter out particles smaller than 300 nm remains even at high temperatures, in a great variety of streams of liquids and gases, in chemically aggressive environments, and at high pressures. This could not have been expected against the background of the filter media already existing.

According to another aspect of the invention, also uncrosslinked polymer fibers heat-resistant up to 200° C., can be used. Also for these fibers it has been surprisingly demonstrated that the fine fiber layer does not degrade even under extreme conditions, that is the filtering efficiency is completely preserved. Cross-linking is thus possible in an advantageous manner and for some polymers it may even be possible to dispense with a crosslinker, as heating to 200° C. in the presence of a catalyst may already cause crosslinking of the fibers with each other or with the supporting layer.

The polymer fibers of the fine fiber layer are permanently self-adhering on at least one of the supporting layers and therefore they demand no additional crosslinking agent. They consist, in particular, of polyvinyl alcohol, polyacrylic acid, polyacrylamide, polyamide, polyvinyl amine, polyvinyl formamide, or copolymers formed therefrom, ie, they comprise polymers which are soluble in polar solvents. This guarantees an extremely environmentally acceptable production process.

The polymer fibers within the fine fiber layer may have different diameters thus giving a preferential direction to the fiber layer. Along said direction the polymer fibers are disposed according to thickness in a well-ordered fashion, thus forming a gradient structure within the filter medium. Thereby the filtering properties of said filter medium can be impoved even further, whilst at the same time its thickness can be reduced.

The crosslinker used to bond the polymer fibers to each other and/or to at least one supporting layer is an at least bifunctional chemical compound, preferably a melamine-formaldehyde resin, a urea-formaldehyde resin, an epoxy resin, an acrylic resin, a wet-strength agent, or a mixture of said substances. These crosslinking agents coordinate with the catalyst to provide good three-dimensional crosslinking of the polymer fibers. By this means there is formed an extraordinarily stable fine fiber layer, which is imperative for a filter medium. Said medium also shows a surprisingly good and lasting filter performance under heavy and continuous chemical, thermal, and mechanical stress.

The catalysts used, such as Lewis or Broensted acids, Lewis or Broensted bases or a compound having oxidizing or radical-initiating properties, accelerate the crosslinking process. If crosslinking is caused by energy input in the form of supersonics, electromagnetic radiation, preferably IR or UV radiation, or by electron beams, catalyst residues in the filter medium can be avoided in an advantageous manner. Besides, crosslinker solutions irradiated with UV light are processable for a long period.

According to one favorable advancement, the filter medium is provided with at least one further supporting layer, which comprises or forms a cover layer, a backing layer, or another layer of filtering material, the fine fiber layer being adjacent to the inflow side and/or to the outflow side of at least one of these layers.

In all the macroscopically measurable volume of the supporting layer remains unchanged following application of the polymer fibers of the fine fiber layer. Thus, unlike conventional filters, the filter medium of the invention takes up no additional room despite increased filter efficiency.

It is advantageous if at least one supporting layer comprises organic and/or inorganic fibers or a composite thereof, particularly cellulose, synthetic fibers, or microglass fibers. The cost of these fibrous materials is reasonable and they have advantageous mechanical properties. The latter are improved even more if at least one supporting layer is impregnated and stiffened, or is capable of being stiffened by, eg, a phenolic resin. The overall filter medium now possesses long-lasting good filtering properties and a high degree of dimensional stability even in aggressive environments.

In a special improvement, at least one supporting layer comprises a large-pored base medium having little filtering action or an open-pored joining layer having no filtering properties. This structure makes it possible to bind non-joinable filtering layers to each other and to increase the dust-catching capacity of the filter medium considerably. In another embodiment, one supporting layer is in any case an electret medium, the filtering efficiency of which is likewise improved by the fine fiber layer and, moreover, remains invariable in time.

Filtrate sticking is prevented, if at least one supporting layer of the filter medium has been rendered surface-hydrophobic, for example, by alkylation or silylation (silanization) and/or contains one or more flameproofing agents and/or fluorescent dyes. The quality of the filter medium can be monitored. Added affinity ligands make the filter medium particle-selective even under drastic operating conditions.

In order to increase the filter efficiency, at least one filter medium, but preferably a plurality of filter media together, forms a particle or molecular filter.

A process for the production of a filter medium for use in thru-flow contrivances, in which at least one polymer in the molten state or dissolved in a polar or non-polar solvent is spun by means of a nozzle in an electric field to form polymer fibers, which are laid on a supporting layer in the form of a fine fiber layer, the polymer fibers having an average fiber diameter of less than and/or equal to 1 μm, and in which intermediate spaces are formed between the polymer fibers, is characterized according to the invention in that there is added to the polymer melt or polymer solution a crosslinker and that the polymer fibers placed on the supporting layer, crosslink and/or are crosslinked, with each other and/or with the crosslinking agent under the influence of a catalyst.

Such a process makes it possible to produce fibers smaller than 1 μm quickly and precisely and to cure said fibers at a predetermined point of time depending on the customer's requirements or on the reactivity, which leads to a very robust filter medium having a fine fiber layer which is efficient even in aggressive environments.

If the polymer fibers of the fine fiber layer are produced by electrospinning from a polar, preferably an aqueous solution, no great environmental load results. When working with such a solution it is advantageous to bring a stack of layers comprising at least one supporting layer and at least one fine fiber layer into contact with basic or acid catalysts or with electromagnetic or electron beams. In order to achieve adequate stability and long-lasting high filter efficiency, the supporting layer and the crosslinked or crosslinkable fine fiber layer are impregnated over at least a partial area with another crosslinking agent and rendered are stiff between 140° C. and 180° C. The fine fiber layer and its efficiency will not be impaired thereby.

In a special process variant, the polymer fibers are placed on an unimpregnated supporting layer, and the resulting unimpregnated filter medium is treated as a whole with an impregnating agent and then cured as a whole. This saves separate drying of a previously impregnated supporting layer.

Further features, details, and advantages of the invention may be gathered from the wording of the claims and from the following description of working examples bearing reference to the drawings wherein:

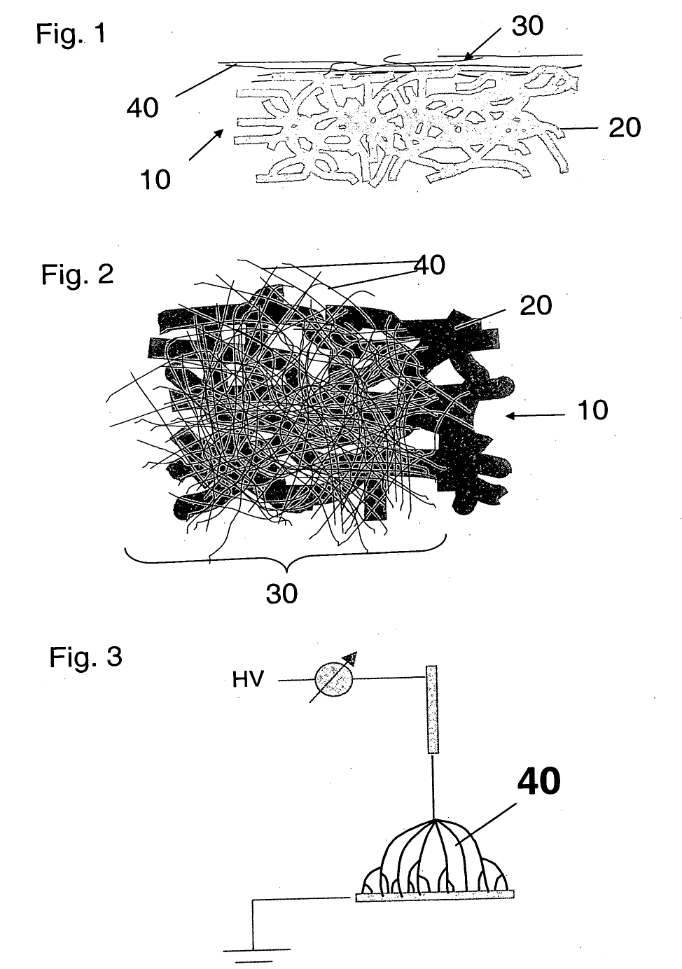

FIG. 1 is a diagrammatic representation of a filter medium in cross-section,

FIG. 2 is a top view of the filter medium shown in FIG. 1,

FIG. 3 is a diagrammatical illustration of an arrangement for electrospinning polymer fibers,

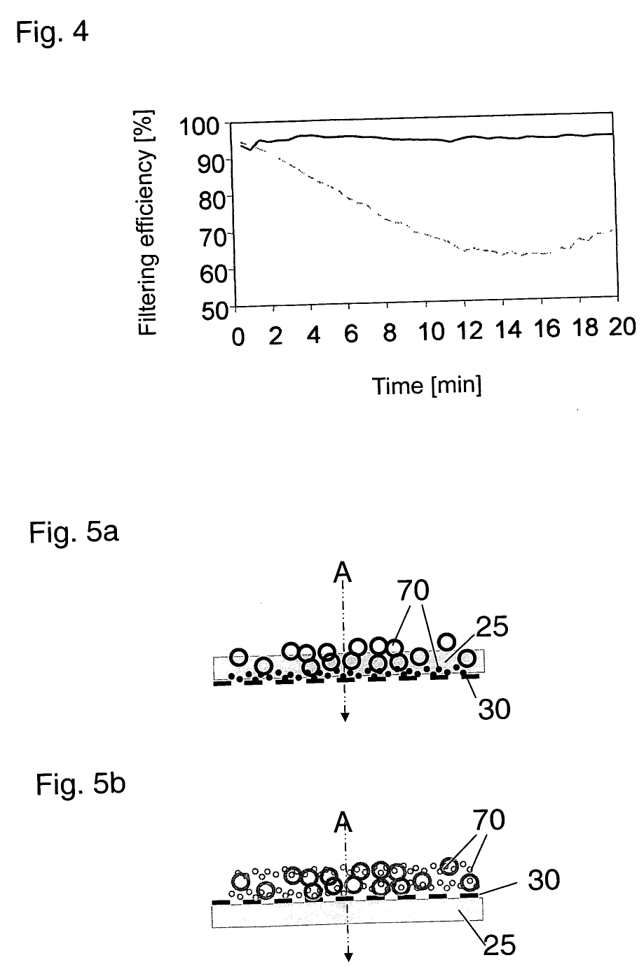

FIG. 4 shows the filtration effect of another embodiment of a filter medium,

FIG. 5a is a cross-sectional view of another embodiment of a filter medium,

FIG. 5b illustrates the embodiment of FIG. 5a when the fluid stream or gas stream flows in the reverse direction,

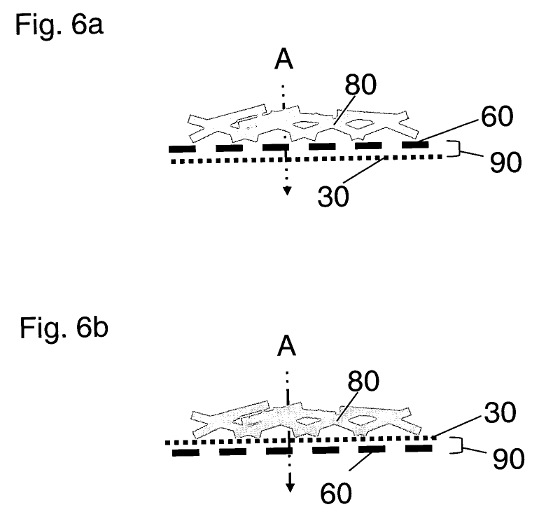

FIG. 6a is a cross-sectional view of yet another embodiment of a filter medium,

FIG. 6b shows a modification of the filter medium of FIG. 6a.

The filter medium designated in FIG. 1 by reference numeral 10 is intended for use as a flat filter 10 in thru-flow devices, such as gas purification plants and fluid reprocessing systems. It has a supporting layer 20 of phenolic resin paper, to which a fine fiber layer 30 of crosslinkable polymer fibers 40 has been applied, said fibers being preferably of polyvinyl alcohol to which a melamine resin has been added. The layer thickness of supporting layer 20 largely consisting of cellulose is—depending on the particular application - between 100 μm and 2000 μm, whilst the individual cellulose fibers having diameters between 10 μm and 20 μm form numerous spacings of micron dimensions. On the other hand, the fine fiber layer 30 having layer thicknesses of 500 nm and some microns in width is more than 10 times thinner. The same applies to the fibers 40 contained in this layer 30, which have diameters between 10 nm and 200 nm and are thus much thinner than the fibers in the supporting layer 20 and form pore sizes ranging down to nanometer dimensions.

As FIG. 2 shows, flat filter 10 thus comprises two overlapping three-dimensional nets of different mesh sizes, namely the supporting layer 20 as support web on the one hand and the fine fiber layer 30 as fine fiber web on the other hand. These two layers stick, by reason of physical and/or chemical interactions, permanently to each other, so that a stable laminar composite is formed. The spacings, which may be regarded as a network of interstices between the fibers of the individual layers, act as particle sieves having mesh sizes in the micron or millimicron range in random distribution. Measurements have shown that, for example, the supporting layer 20 retains, on the average, particles larger than or equal to 1 μm to an extent of 95%, while the fine fiber layer 30 in addition effectively prevents passage through the filter medium 10 of particles which are at least 2.5 times smaller, which leads to very good filtering rates.

The fibers 40 in the fine fiber layer 30 are placed directly by the electrostatic spinning process on paper 20, impregnated with reactive resins such as phenolic resin. To this end, an aqueous solution of polyvinyl alcohol is catalytically acidified and a melamine-formaldehyde resin is added thereto as crosslinking agent. This solution is then homogeneously electrospun onto the supporting layer 20, as illustrated in FIG. 3, by which means the fine fiber layer 30 is formed. The latter forms, on the supporting layer 20, a permanently adhering mass of entangled fibers.

Following application of the fine fiber layer 30, also referred to as the nano-fine layer, the filter 10 is, if required, formed to a preset geometric shape and then treated for a few minutes at a temperature between 140° C. and 180° C. This causes the fibers 40 of fine fiber layer 30 to crosslink with each other completely. The supporting layer 20 impregnated with phenolic resin cures to impart exceptionally high overall dimensional stability to medium 10. It exhibits virtually no swelling behavior and is at the same time insoluble in water.

As shown in the following Tables 1 and 2, the application of the fine fiber layer 30 distinctly improves the initial filtration efficiency of filter 10 in a gas stream, the air permeability of the overall filter medium 10 dropping only slightly. Another advantage of the invention consists in that the separation capacity of the filter medium 10 does not drop even in moist environments or after contact with water.

TABLE 1
Air permeability and separation efficiencies (PALAS ®
fractional efficiency) of the filter medium following heat
treatment and addition of water

| | | Sup- | Filter | Filter medium |
|---|---|---|---|---|
| | | porting | medium | following |
| | Sup- | layer | following | thermal treatment |
| | porting | with fine | thermal | and treatment |
| | layer | fiber layer | treatment | with water |
| Air permeability | 185 | 140 | 140 | 140 |
| [L/m²s] | | | | |
| 80% Separation of | 0.604 | n.a. | n.a. | n.a. |
| particles having | | | | |
| particle sizes of μm | | | | |
| 95% Separation of | 2.707 | 0.34 | 0.34 | 0.34 |
| particles having | | | | |
| particle sizes of μm | | | | |

n.a. = not analyzable because out of measuring range (<0.294 μm)

TABLE 2
Weight per unit area, thickness, air permeability and separation
efficiencies (PALAS ® fractional efficiency) and temperature
resistance of the filter medium as a function of the amount of fine fiber
layer. Fine fiber layer on the downstream side.

| | No | | More | |
|---|---|---|---|---|
| | fine fiber | Some fine | fine fiber | Much fine |
| | layer | fiber layer | layer | fiber layer |
| Weight per unit area | 120 | 120 | 120 | 120 |
| [g/m²] ISO 536 | | | | |
| Thickness [mm] | 0.76 | 0.76 | 0.76 | 0.76 |
| ISO 534 | | | | |
| Air permeability [L/m²s] | 238 | 221 | 180 | 166 |
| DIN 531887 | | | | |
| (A = 20 cm²) | | | | |
| 80% Separation of | 0.523 | n.a. | n.a. | n.a. |
| all particles having a | | | | |
| particle size of μm | | | | |
| DIN 44956/2 | | | | |
| 95% Separation of all | 1.075 | 0.604 | 0.523 | n.a. |
| particles having a | | | | |
| particle size of μm | | | | |
| DIN 44956/2 | | | | |
| Heat resistance [° C.] | | >180 | >180 | >180 |

n.a. = not analyzable, since out of measuring range (<0.294 μm)

Tables 1 and 2 show that the separation efficiency of the filter 10 is changed by the curing process at temperatures of 180° C. not at all or only insignificantly. On the contrary, the advantageous filtering properties remain almost unchanged even when the filter medium is used at temperatures above 180° C. The filtering action is all the more pronounced, the more polymer fibers 40 are used as fine fiber layer 30 for the retention of minute particles and placed on a resin-impregnated paper substrate used as supporting layer 20. It is also conspicuous that the fine fiber layer 30 does not measurably increase the weight and thickness of the paper substrate or, consequently, its volume. This also applies to a fine fiber layer 30 when it is very closely applied to the substrate. Consequently a considerably higher filter performance can be achieved without having to supply the user with a larger and heavier filter medium 10. It is therefore unnecessary to accomodate plants to new filter dimensions.

Furthermore, the filter medium 10 thus designed has the same mechanical properties as those found in the paper substrate used as supporting layer 20. Fine fiber layer 30 and paper substrate together behave as a single supporting layer 20. Thus even with extreme chemical, thermal or mechanical stress on the individual filtering layers 20, 30, there do not occur any interfacial phenomena, such as strain due to differing thermal expansion coefficients or varying compressibility coefficients. This homogeneous dimensional stability of a filter medium 10 cannot be observed in filters containing melt-blown fibers.

In addition to the water stability of the filter media 10 and the fine fiber layer 30 the filter media 10 may be successfully used in liquid filtration, as shown by Table 3.

TABLE 3
Air permeability, dust-catching capacity and separation efficiencies
of liquid filters (oil) comprising various paper types A, B, C, some of
which are coated with a fine fiber layer. Multipass-test with synthetic
oil, fine fiber layer on the upstream side.

| | | | Paper B + | | Paper C + |
|---|---|---|---|---|---|
| | | | fine | | fine |
| Medium | Paper A | Paper B | fiber layer | Paper C | fiber layer |
| Air permeability | 17 | 50 | 40 | 250 | 75 |
| [L/m²s] | | | | | |
| Dust uptake [g] | 0.4 | 0.95 | 0.95 | 2.0 | 2.1 |
| β value(20) [μm] | 6 | 12 | 8 | >16 | 12 |

The β value denotes the filter performance in a liquid. It is a measure of the ability of a filter to separate particles down to the stated size from a liquid. Table 3 illustrates the determination of β(20) values. The number 20 indicates that per 20 particles one particle (ie 5%) passes through the filter, which is equivalent to a separation efficiency of 95%. It is seen that the use of fine fiber layer 30 prevents substantially smaller particles from passing through the filter medium 10 to an extent of 95 %. For example, uncoated paper B retains particles down to a size of 12 μm, whilst coated paper B retains particles down to a size of 8 μm. Thus the latter comes very near to the separation capacity of paper A but can at the same time keep its own dust-catching and air permeability characteristics, which are much better than those of paper A.

Consequently the flat filter 10 of the invention is not only waterstable as a result of impregnation and crosslinking. But in addition the fine fiber layer 30 produced from polar, mostly aqueous solution remains completely intact at temperatures of up to 180° C. or even up to 200° C. The entire filter 10 and particularly the fine fiber layer 30 keeps its high filter performance even under extreme conditions, which opens up numerous application possibilities not realizable with conventional filters. Thus it can be used, for example, in aqueous, strongly salt-laden media as well as in organic or organometallic solvents, since the fine fiber layer 30 is not decomposed. It is equally suitable for use in the separation of solid matter from petrochemical liquid products as for the purification of corrosive waste water having a high heavy-metal content. In addition, hot, caustic vapors of acids, bases or aggressive gasses are not detrimental to the filter performance.

The filter medium 10 is also characterized in that in the region of the fine fiber layer 30 no deeply penetrating filter cake is formed. The close-meshed characteristics of this filtering layer 30 has the effect that a very large surface area is presented. Thus particles are mainly caught in the surface region, ie, the top network portion of the fine fiber layer 30. They are easy to remove from the filter medium 10 by means of compressed air blown through in the reverse direction. The formation of a thin filter cake has the added advantage that filter medium 10 remains continuously permeable and the power of flow does not have to be raised in order to overcome the resistance caused by the filter cake.

The fine fiber layer 30 is produced by electrostatic spinning of a great variety of polymers from an electrode. In this process shown diagrammatically in FIG. 3 branched fiber shapes may also form. For example, electrospinning from the melt or solution can be used in the case of the following thermoplastics and/or duroplastics: polyacrylonitrile, polyacrylate, polymethacrylate, ethylene glycol monomethacrylate, hydroxyethyl methacrylate, polyvinylidene chloride, polyvinyl chloride, chlorinated polyvinyl chloride, polyvinylidene fluoride, polychlorotrifluoroethylene, polysulfones, polyether sulfones, sulfonated polysulfones, polyphenylene sulfide, polyimides, polyamides, polycarbonates, arylates, polyaryl ether ketones, polystyrenes, polyvinyl butyral, polyurethane, polyvinyl acetate, polyvinyl acetal, polyvinyl ether, polyethylene, polypropylene, polybutene-1, polymethyl pentene, polyoxymethylenes, polyesters, and polyacrylamides, whilst copolymers, oligopolymers, and block copolymer or block oligopolymer forms of these molecules can be used. The water-soluble polymers used are, in addition to polyvinyl alcohol, the polymers polyacrylic acid, polyethylene oxide, and/or polyvinylpyrrolidone. In aqueous solution, the latter can be handled in an environmentally acceptable manner.

In order to acquire particularly high separation efficiencies combined with a high degree of air permeability, is it useful to lay the polymer fibers 40 according to size and in a well-ordered manner on a supporting web serving as supporting layer 20. This is carried out by first of all laying out coarser fibers having a diameter of down to 1 μm, onto which visibly thinner fibers 40 are laid so that a funnel-shaped filtering action is produced. The diameter of the individual fibers is governed by the parameters set on the spinning electrode and, in particular, by the viscosity of the sprayed polymer solution or melt. These parameters are specific for each mixture of polymer, crosslinking agent and catalyst.

The fibers 40 electrospun out of the respective polymer crosslink with each other and/or with reactive groups in the supporting layer 20. Such crosslinking can be initiated at various points of time depending on the particular application. The crosslinking agents used comprise melamine-formaldehyde resins and urea-formaldehyde resins, alternatively epoxide resins, acrylic resins, wet-strength agents, and polyester resins, or a mixture of said substances. Usually, these at least bifunctional crosslinkers are mixed homogeneously with the polymer and a catalyst in the electrostatic solution or melt to be electrospun. This denotes crosslinking in situ, ie at the time of formation of the electrospun fibers 40. If this process takes place too quickly, the catalyst may alternatively, for example in the form of an extremely fine falling spray mist, be brought into contact with the polymer fibers 40 following production thereof by electrospinning. If the crosslinking rate is not high enough, an increase in the temperature to from 140° C. to 180° C. raises the reaction rate.

By reason of the high curing temperatures of from 140° C. to 180° C. for the filter medium 10, it may even be possible to dispense with a crosslinker in the case of electrospun polymers having reactive groups or side chains, as is the case, for example, with certain polyamides. The presence of a catalyst is in itself sufficient to achieve crosslinking between and/or in the individual polymer fibers 40, which makes them chemically inert, insoluble in water, and temperature-resistant. These are consequently to be regarded as fibers which are permanently self-adhering to the supporting layer 20 and also to each other.

In addition to the crosslinked fine fiber layer 30, individual filtering layers 20, 30 are rendered dimensionally stable and water-repellent by the use of impregnating agents. For this purpose, use is preferably made of synthetic resins, such as phenoplasts, aminoplastics (melamine resins, urea-formaldehyde resins), unsaturated polyester resins, acrylic resins, epoxy resins, alkyd resins, polyurethane resins, silicone resins, vinyl polymers, and polymeric fatty acids or mixtures thereof. However, use may also be made of naturally occurring substances such as glue, starch, or casein. Phenolic resins are used to a large extent under a great variety of reaction conditions, but curing to completion currently takes place only at a temperature of from 140° C. to 180° C. However, this will not be a problem for the filter medium of the invention. Usually, electrospun polymer fibers 40 are laid on a resin-impregnated supporting layer 20 which has already been cured or alternatively only dried but not yet cured.

However, tests have been carried out to provide one or more unimpregnated supporting layers 20 with a fine fiber layer 30. The resulting, unfinished filter medium 10 is then, as a whole, impregnated by or soaked in a reactive resin solution and cured at temperatures between 140° C. and 180° C. If this is done, complete crosslinking of fine fiber layer 30 and complete drying and curing of supporting layer(s) 20 take place simultaneously during a single heat treatment. There is therefore no more need for a supporting layer 20, which must be cured in advance, for example, a previously dried phenolic resin paper. It should be noted, however, that the polymer fibers 40 in the fine fiber layer 30 are only completely crosslinked and therefore completely insoluble and/or dimensionally stable following the heat treatment. The reactive resin used for impregnation may not therefore be dissolved in a solvent in which the polymer fibers 40 in the fine fiber layer 30 are also soluble. For example, aqueous phenolic resin solutions are unsuitable when the fine fiber layer 30 consists of uncrosslinked polyvinyl alcohol fibers.

The choice of catalyst for crosslinking the polymer fibers 40 in fine fiber layer 30 or for impregnating and strengthening the remaining supporting layers 20 depends on the polymer and/or crosslinker used. Lewis or Broensted acids, and their bases are usually used. Suitable for crosslinking polyvinyl alcohol with melamine resins is, for example, dilute citric acid, formic acid, or orthoboric acid. Radical bridging of acrylamide polymer chains is advantageously achieved with a few drops of a potassium peroxydisulfate solution. Other compounds having oxidizing or radical-initiating properties, such as AIBN or a dilute KMnO₄ solution, are likewise useful. Crosslinking and stiffening of the filtering layers 20, 30 treated with synthetic resin is also achieved by high temperature treatment, by UV irradiation, or by means of electron-beam curing.

For the supporting layers 20, ie the fibrous layers serving as support, there are mainly used celluose fibers and synthetic fibers in a great variety of arrangements. The latter impart to filter medium 10 particularly resistance to petrochemical products, especially oils and used oils. The synthetic fibers can, for example, be interwoven with the cellulosic fabric for strengthening the same so that a blended cellulose/synthetic fiber fabric containing variable percentages by weight of the individual fibers is formed. Furthermore, cellulose nonwovens can be laminated with man-made nonwovens, ie, a cellulose layer is laminated with or bonded to a synthetic layer. Finally, a special laminating technique may be carried out, ie, spot-welding of fiber layers by means of synthetic fibers. The use of mixtures of various types of fiber is a simple way of ensuring that at least one supporting layer 20 comprises fibers having not only diameters greater than 1 μm but also some diameters smaller than and/or equal to 1 μm.

In another embodiment, the supporting layer 20 consists of microglass fibers (MGF) or a blended microglass/cellulose fabric. The combination of synthetic fibers with microglass fibers is also possible, if required. MGFs possess a higher separating or filtering capacity than cellulose fabrics. However, the application of crosslinkable fine fiber layer 30 can here again achieve marked further increase in the filter performance whilst at the same time considerably reducing the need for the otherwise required amount of expensive micro-glass-fiber paper. Thus it is possible, for example, to improve an F7 filter, which is capable of catching 85% of all particles having a diameter of 300 nm, to a F9 filter, which prevents 98% of all 300 nm large particles from penetrating the multifiber layer. Optimization of the parameters layer thickness, size, and alignment of the fibers, and also straining and stretching of the same can even achieve quality standards for HEPA filter media (from 85 to 99,995% retentivity) and ULPA filter media (from 99,9995 to 99,999995% retentivity), the filters being not only water-resistant but also capable of being used under extreme temperature conditions.

Of particularly interest is an embodiment of the invention, in which fine fiber layer 30 is laid onto electret media, ie, electrostatically charged substrates. These media are characterized by a high filter performance, which however drops much within a few minutes after the commencement of use. For example, in the case of the electret medium Technostat® there is instead of 95% of all of the particles to be separated after a period of 14 minutes an effective retention of only 63%, as shown by the dashed curve in FIG. 4. The cause of this resides in the fact that the electrostatic charge on the electret layer decreases as the amount of caught particles increases. However, if such an electret medium is provided with a fine fiber layer 30 of crosslinkable polymer fibers 40, there is no drop in the high initial filtering efficiency. On the contrary, this is even increased, as indicated by the continuous line in FIG. 4, and remains at this constant high level.

A cheap and at the same time very efficient construction of a filter medium 10 makes use of a large-pored base medium 25 as supporting layer 20, as illustrated in FIG. 5a. This large-pored nonwoven 25 has only a low filtering effect but is capable of absorbing large amounts of dust particles 70 without the necessity to continuously raise the inflow pressure during the filtering operation in order to guarantee constant high permeability for a gas or liquid. In order to improve the separation efficiency of this less efficient supporting layer 25 to a marked degree, a fine fiber layer 30 of electrospun crosslinked or crosslinkable polymer fibers 40 is placed thereon. The resulting improvements in the values for dust absorption and separation efficiency can be seen from Table 4 below.

TABLE 4
Increase in the dust absorption and separation efficiency by coating large-pored base media with
a fine fiber layer of electrospun polymer fibers. Determination of the filtration behavior in solution (Multipass-
test with synthetic oil, fine fiber layer on the upstream side) and in a gas stream (test dust: SAE fine,
determined by gravimetry, fine fiber layer on the downstream side)

| | Liquid filtration | | | | | |
|---|---|---|---|---|---|---|
| | | | β | Air filtration | | |
| | Air permeability | Dust uptake | value(20) | Air permeability | Dust uptake | Filtration |
| Medium | [L/m²s] | [g] | [μm] | [L/m²s] | [g] | efficiency [%] |
| Paper A | 17 | 0.4 | 6 | 230 | 1.8 | 97.6 |
| Paper B | 50 | 0.95 | 12 | | | |
| Paper B + fine | 40 | 0.95 | 8 | | | |
| fiber layer | | | | | | |
| Paper C | 250 | 2.0 | >16 | 1400 | 4.7 | 84 |
| Paper C + fine | 75 | 2.1 | 12 | 900 | 4.5 | 98.6 |
| fiber layer | | | | | | |

The retentivity in solution, denoted by the β (20) value in column 4, was determined in the manner already explained under Table 3. However, the separation efficiency given in column 7 relates to all of the catchable particles and not to a PALAS retention, which, as stated in Tables 1 and 2, gives the particle size as a function of a percentage filtering coefficient.

The paper A given as reference retains a very high percentage of all particles in a solution, or in a gas stream. In the liquid 95% of all particles greater than or equal to 6 μm are stopped, while in a gas 97.6% of all detectable particles are prevented from passing through the filter medium 10. However, this high separating efficiency is achieved only at the expense of very low air permeability values and a low degree of capture of dust particles 70.

Papers B and C, on the other hand, remove from 2.3 times to 5.2 times more dust particles 70 than paper A. However, the size of the particles which they can effectively catch in a liquid is about 2 to 2.7 times greater. In a gas stream, they effectively prevent only 84% of all particles from flowing through the filter.

Covering the papers B and C with a fine fiber layer 30 increases their separation efficiency in a gas stream to a marked degree and even beyond that of paper A, ie, to 98.6%. In addition, the separation efficiency in solution is displaced toward smaller β values, for example, from 12 μm to 8 μm. Nevertheless the dust-catching capacity of the filter medium 10 remains on the whole the same and can in some cases show an improvement over the uncoated supporting layer 20. Furthermore, the inflow pressure on the coated base medium 25 during a filtering operation does not rise or drop below a critical value beyond the filter medium 10, which distinctly increases the service life and lifetime of the filter.

FIG. 5b shows the filter medium 10 of FIG. 5a with the stream flowing in the reverse direction. In this case, the dust particles 70 to be filtered out impinge directly on the fine fiber layer 30. They form thereon an unordered dust particulate layer (filter cake) containing dust particles 70 of various sizes. If, however, the latter impinge on the large-pored base medium 25, as may be seen in FIG. 5a, small dust particles 70 (small circles) will penetrate more deeply than the larger particles (big circles) for which reason the dust-catching capacity is in this case higher.

Another embodiment of the invention is characterized in that the supporting layer 20 and/or the fine fiber layer 30 is/are covered by another supporting layer 20 as cover layer. This cover layer is, for example, a coating for protection of the respective layer from destructive influences without interfering with the filter performance.

Preferably, the material used for this layer is the same basic fibrous material as that present in the first supporting layer 20 or the fine fiber layer 30. Alternatively, however, different materials may be used, these being applied as a thin coat. In this case the cover layer has not only a protective function but also assumes, by reason of its different chemical properties from those of the supporting layer 20, a separating function, and besides the mesh width, ie, the pore size of this layer, the reciprocal effect of the various chemical side-groups of the individual fibers on the substance passing through the filter is utilized.

The additional supporting layer 20 can also be inserted as a backing layer or as a spacer between the first supporting layer 20 and the fine fiber layer 30. This is expedient, for example, when large amounts of particles are transported and/or high thru-flow rates occur. If fine fiber layer 30 and supporting layer 20 cannot, by reason of their different chemical surface compositions, adhere permanently to each other, said backing layer additionally acts as a joining agent. For example, a layer of polypropylene fibers and another of polysulfone fibers can be made to adhere more permanently to each other by introducing polyacrylic fibers or even polyamide fibers between these two fibrous layers.

Certain supporting media cannot be directly provided with a fine fiber layer 30 of spun polymer fibers 40, for mechanical reasons, so that their filter performance cannot be improved by this means. In particular, it is not possible to directly apply a fine fiber layer to an uneven or superficially rough filter web 80 because single projecting fibers thereof would tear the fibrous network of the fine fiber layer 30 or at least make it very uneven. The fine fiber layer 30 is therefore applied to an open-pore joining layer 60, which is very thin and therefore almost devoid of any filtering action. The resulting composite 90 can then, as shown in FIGS. 6a and 6b, be bonded to the superficially rough or uneven filter web 80, for example, by spot-lamination.

The connecting layer 60 in FIG. 6a serves two essential purposes. As a further supporting layer 20, it serves as a means of bonding filter web 80 and is a backing layer for the fine fiber layer 30. In the construction shown in FIG. 6b the layer 30 of the composite 90 is directly adjacent to the superficially rough filter web 80. This embodiment is of advantage when the fine fiber layer 30 is to be protected from external influences as far as possible without damage by the superficially rough filter web 80 being expected.

If it is desired to avoid sticking of particularly firmly adhering filtrate or filter dust to the filter, the invention provides a passivated form of the filter medium 10 described. To this end, the individual layers or the different fibers are surface-hydrophobed at least in part, use being mainly made of alkylating or silylating (silanizating) agents. Partially fluorinated or perfluorinated polymer fibers are already characterized by their hydrophobic surface and no longer require special treatment. However, they are expensive to purchase, for which reason they will only be used when highest demands are placed on the filter medium 10.

In addition to said surface-passivation, the filter medium 10 may, in another embodiment, be specifically provided with protective particles and/or signal molecules. For example, fluorescent dyes indicate by their absorbency the extent to which filter medium 10 is loaded with particles, which makes it possible to draw conclusions on the filter performance. Furthermore use is primarily made of affinity ligands besides a great variety of flameproofing agents. They are linked to the respective fibrous layer by covalent bonds and help separate specific species from the air or liquid to be filtered, for biological, biochemical, and analytical research purposes. Thus lectins, for example, are suitable for adsorbing sugar-bearing particles. Streptavidin is another affinity ligand, which selectively removes, by filtration, any particles exhibiting a biotin group. In particular, in view of increased loading of the environment with allergens and biological germs, such as viruses or, eg, abnormally-folded prion protein suspected to act as a trigger for bovine spongiform encephalopathy, coupling of ligands to the very efficient filter medium 10 is industrially and economically extremely interesting.

The filter medium 10 is thus designed such that the fine fiber layer 30, as shown in FIG. 5, is next to the supporting layer 20, whether present on the inflow or outflow side, and further supporting layers 20 can be placed between these layers to form cover layers or backing layers. In addition to the basic configuration, the filter medium 10 is designed for specific space-saving applications such that the thickness of the supporting layer 20 is equal to that of the fine fiber layer 30. A particle or molecular filter comprises one or more series-connected filter media 10.

The breaking force of the filter medium 10 depends on its structure, for which reason, eg, only an approximate value can be given for the supporting layer 20, which is usually greater than 35 N in the longitudinal direction and greater than 25 N in the transverse direction. Furthermore, the fiber thickness of the fibers in the fine fiber layer 30 can only be defined by an average diameter, since the electrostatic production of spun fibers under normal operating conditions leads to a statistical distribution of fibers of various diameters. However, it may be assumed that the diameter of the fine fibers, ie, the polymer fibers 40 in the fine fiber layer 30, is not smaller than 10 nm.

The invention is not restricted to any of the embodiments described above but can be modified in diverse ways. Thus, for example, carbon fibers or silica fibers can be used in the supporting layer 20. However, these have to be preformed from hydrocarbons, such as cellulose, methyl cellulose, propyl cellulose, cyclodextrin, or starch, or from the corresponding silanols or silicones by pyrolysis with exclusion of air. Furthermore, the polymers and their pyrolyzates (carbon fibers) stated for use in the fine fiber layer 30, and also silica fibers derived from silicon compounds and even metal fibers may be used. A filter medium 10 comprising a supporting layer 20 of metal fibers and a fine fiber layer 30 of carbon fibers can be used at extremely high temperatures ranging up to 1,500° C.

All of the features and advantages, including structural details, spatial arrangements, and process steps, disclosed in the claims, description and drawing(s) can be essential to the invention both independently and in a great variety of combinations.

It is seen that there has been developed a novel filter medium 10, which effectively catches not only microparticles but also particles having nanometer dimensions. According to the invention, it comprises at least one supporting layer 20 and at least one fine fiber layer 30, the former preferably being composed of crosslinked cellulose fibers and micro-glass fibers, or alternatively of polymeric fibers. The diameters of the fibers in the supporting layer 20 are in the micron range and the pores of this layer mostly have cross-sections in the square micron range. The very light fine fiber layer 30 having a weight per unit area of less than 1 g/m² possesses pores ranging down to nanometer dimensions and is thermally stable at temperatures above 180° C. It comprises fibers 40 obtained from polymers by electrostatic spinning and having diameters in the nanometer range. In order to crosslink individual fibers 40 with each other or with the supporting layer 20 and thus to render them insoluble in water and chemically and thermally stable, various resins, for example, melamine resins are used. For protection and stability purposes, the filter medium 10 can be supplemented with supporting or cover layers.

List of Reference Symbols

A direction of inflow
HV high voltage
10 filter medium
20 supporting layer
25 large-pored base medium
30 fine fiber layer
40 polymer fibers
60 open-pore joining layer
70 dust particles (of various sizes)
80 rough filter web
90 composite of 60 and 30

1. A filter medium for use in thru-flow contrivances, containing at least one supporting layer (20) and at least one fine fiber layer (30) permanently adhering to said supporting layer (20), said fine fiber layer (30) comprising electrostatically spun polymer fibers (40) having an average fiber diameter of less than and/or equal to 1 μm, wherein, due to the action of a catalyst, the polymer fibers are crosslinked with each other directly or indirectly via a crosslinking agent (crosslinker), which crosslinker and/or the crosslinked polymer fibers (40) are resistant to a temperature of up to 200° C.

2. A filter medium as defined in claim 1, wherein the uncrosslinked polymer fibers (40) are resistant to temperature of up to 200° C.

3. A filter medium as defined in claim 1, wherein the polymer fibers (40) are permanently fixed by self-adherence to at least one of the supporting layers (20).

4. A filter medium as defined in claim 1, wherein the polymer fibers (40) comprise polymers soluble in polar solvents, particularly polyvinyl alcohol, polycarboxylic acids, polyacrylamide, polyamide, polyvinyl amine, polyvinyl formamide, or copolymers formed therefrom.

5. A filter medium as defined in claim 1, wherein the polymer fibers (40) in the fine fiber layer (30) have different diameters.

6. A filter medium as defined in claim 1, wherein the fine fiber layer (30) has a preferential direction, in which the polymer fibers (40) are disposed in a well-ordered manner according to their diameter size.

7. A filter medium as defined in claim 1, wherein the crosslinking agent used to join the polymer fibers (40) to each other and/or to at least one supporting layer (20) is an at least bifunctional chemical compound, preferably a phenolic resin, a melamine-formaldehyde resin, a urea-formaldehyde resin, an epoxy resin, an acrylic resin, a wet-strength agent, or a mixture of said substances.

8. A filter medium as defined in claim 1, wherein the catalyst is a Lewis acid or Broensted acid, a Lewis base or Broensted base, or a compound having oxidizing or radical-initiating properties.

9. A filter medium as defined in claim 1, wherein the catalyst comprises heat, supersonic waves, electromagnetic radiation, preferably IR or UV radiation, or an electron beam.

10. A filter medium as defined in claim 1, wherein at least one further supporting layer (20) is provided which is or forms a cover layer, a backing layer, or another layer of filtering material, the fine fiber layer (30) being adjacent to at least one of these layers on the inflow and/or outflow side.

11. A filter medium as defined in claim 1, wherein the macroscopically measurable volume of the supporting layer (20) is unchanged following the application of the polymer fibers (40) of the fine fiber layer (30).

12. A filter medium as defined in claim 1, wherein at least one supporting layer (20) comprises organic and/or inorganic fibers, or a composite mixture thereof, particularly cellulose, synthetic fibers, or microglass fibers.

13. A filter medium as defined in claim 1, wherein at least one supporting layer (20) is impregnated with and stiffened by, or is capable of being stiffened by, a phenolic resin for example.

14. A filter medium as defined in claim 1, wherein at least one supporting layer (20) is a large-pored base medium (25) having a low filtering effect or an open-pore joining layer (60) having no filtering properties.

15. A filter medium as defined in claim 1, wherein at least one supporting layer (20) is an electret medium.

16. A filter medium as defined in claim 1, wherein at least one supporting layer (20) is surface-hydrophobic, for example due to alkylation or silylation (silanization).

17. A filter medium as defined in claim 1, wherein at least one supporting layer (20) contains one or more flameproofing agents and/or fluorescent dyes.

18. A filter medium as defined in claim 1, wherein at least one supporting layer (20) is provided with affinity ligands.

19. A particle filter or molecular filter comprising at least one filter medium (10) as defined in claim 1.

20. A process for the production of a filter medium (10) for use in thru-flow contrivances, in which at least one polymer, in the molten state or dissolved in a polar or non-polar solvent, is spun by means of a nozzle in an electric field to form polymer fibers (40), which are placed on a supporting layer (20) in the form of a fine fiber layer (30), which polymer fibers (40) have an average fiber diameter smaller than and/or equal to 1 μm, intermediate spaces being formed between said polymer fibers (40), wherein
a) a crosslinking agent is added to the polymer melt or the polymer solution and
b) the polymer fibers (40) placed on the supporting layer (20) crosslink and/or are crosslinked with each other and/or with the crosslinking agent with the aid of a catalyst.

21. A process as defined in claim 20, wherein the polymer fibers (40) in the fine fiber layer (30) are produced by electrospinning of a polar, preferably aqueous, solution.

22. A process as defined in claim 20, wherein a stack of layers comprising at least one supporting layer (20) and at least one fine fiber layer (30) is brought into contact with basic or acid catalysts or with electromagnetic or electron beams.

23. A process as defined in claim 20, wherein
a) the polymer fibers (40) are placed on an unimpregnated supporting layer (20), v
b) the resulting unimpregnated filter medium (10) is treated as a whole with an impregnating agent,
c) and is then cured as a whole.
